(19) United States
(12) Patent Application Publication
(10) Pub. No.: US 2022/0228418 A1
(43) Pub. Date: Jul. 21, 2022

(54) OVERHEAD DOOR SYSTEM AND RETROFIT KIT

(71) Applicant: Hall Labs LLC, Provo, UT (US)

(72) Inventors: David R. Hall, Provo, UT (US); Jerome Miles, Spanish Fork, UT (US)

(73) Assignee: Hall Labs LLC, Provo, UT (US)

(21) Appl. No.: 17/714,707

(22) Filed: Apr. 6, 2022

Related U.S. Application Data
(63) Continuation-in-part of application No. 16/805,771, filed on Feb. 29, 2020.
Application No. 16/805,771 is a continuation-in-part of application No. 17/360,069, filed on Jun. 28, 2021.
Application No. 17/360,069 is a continuation-in-part of application No. 17/355,112, filed on Jun. 22, 2021.

(51) Int. Cl. E05F 15/684; E05D 13/00; E05F 1/16

(52) U.S. Cl. CPC E05F 15/684; E05D 13/1261; E05F 1/16; E05Y 2201/416; E05Y 2201/434; E05Y 2201/474; E05Y 2900/106; E05Y 2201/652; E05Y 2201/656; E05Y 2201/684; E05Y 2800/70; E05Y 2201/422; E05Y 2201/41; E05Y 2201/484

(57) ABSTRACT

An overhead door system is disclosed, which includes a first track and a second track mounted on opposite sides of an opening. Each track has a vertical portion, a transition portion, and a horizontal portion, with the transition portion being between the vertical portion and the horizontal portion. An overhead door engages the first and second tracks on opposite sides of the overhead door and is movable along the first and second tracks between a closed, vertical position and a raised, horizontal position. A motor unit has a motor that is mounted above the horizontal portions of the first and second tracks. A rail is parallel to and disposed between the horizontal portions of the first and second tracks. The rail carries a carriage configured to move in a first direction to raise the overhead door and in a second, opposite direction to lower the overhead door. A connecting member is pivotally attached at one end near a top edge of the overhead door and attached at an opposite end to the carriage. A one-way bearing is disposed between the motor and the carriage. The motor, as it rotates in a first rotational direction, applies force to the carriage to move the carriage in the first direction to raise the overhead door. Nevertheless, owing to the one-way bearing, the motor, as it rotates in a second, opposite rotational direction, does not apply force to the carriage to move the carriage in the second direction to lower the overhead door. A kit to retrofit an overhead door system with a one-way bearing is also disclosed.

### CROSS-REFERENCE TO RELATED PATENT APPLICATIONS

This application claims priority to U.S. patent application Ser. No. 16/805,771 filed Feb. 29, 2020, entitled “Mechanism for Opening and Closing an Overhead Door Including One Way Bearing,” published as U.S. Patent Application Publication No. 2021/0270079 which is incorporated herein by reference in its entirety. This application also claims priority to U.S. patent application Ser. No. 17/360,069 filed Jun. 28, 2021, entitled “Overhead Door Opener System with One Way Bearing” which is incorporated herein by reference in its entirety. This application also claims priority to U.S. patent application Ser. No. 17/355,112 filed Jun. 22, 2021, entitled “Spring Assisted Overhead Door” which is incorporated herein by reference in its entirety.

### TECHNICAL FIELD

The present disclosure is directed to an overhead door opener system having a one-way bearing safety mechanism and a starting spring to enable a ceiling-mounted overhead door opener to close the overhead door.

### BACKGROUND

The present disclosure concerns systems and methods for raising and lowering overhead door such as a garage door, commercial door, roller door, or loading doors, etc. Conventional methods for opening and closing overhead doors include some form of stopping mechanism. Many of these mechanisms employ optical sensors near the ground to stop the garage if an impediment enters the field of vision of the sensors, or torque limiters and force-feedback mechanisms. An optical sensor near the ground has a limited field of view and may not stop the overhead door if an impediment is not in the field of view. There is a need in the art for an improved, reliable, and safe mechanism to raise and lower overhead doors.

### SUMMARY

Embodiments of the present disclosure are directed to an overhead door system, which includes a first track and a second track mounted on opposite sides of an opening. Each track has a vertical portion, a transition portion, and a horizontal portion, with the transition portion being between the vertical portion and the horizontal portion. An overhead door engages the first and second tracks on opposite sides of the overhead door and is movable along the first and second tracks between a closed, vertical position and a raised, horizontal position. A motor unit has a motor that is mounted above the horizontal portions of the first and second tracks. A rail is parallel to and disposed between the horizontal portions of the first and second tracks. The rail carries a carriage configured to move in a first direction to raise the overhead door and in a second, opposite direction to lower the overhead door. A connecting member is pivotally attached at one end near a top edge of the overhead door and attached at an opposite end to the carriage. A one-way bearing is disposed between the motor and the carriage. The motor, as it rotates in a first rotational direction, applies force to the carriage to move the carriage in the first direction to raise the overhead door. Nevertheless, owing to the one-way bearing, the motor, as it rotates in a second, opposite rotational direction, does not apply force to the carriage to move the carriage in the second direction to lower the overhead door.

Preferably, the overhead door system also includes a spring which is energized as the overhead door travels a final segment of the horizontal portion of the first and second tracks nearest the motor unit. As such, the spring and gravity provide the force to move the carriage in the second direction to lower the overhead door.

Further embodiments are directed to a kit to retrofit an overhead door opener comprising a motor that drives a sprocket that, in turn, drives an endless chain. The kit includes a one-way bearing configured to be placed between the motor and the sprocket. The motor can drive the sprocket in a first rotational direction to lift an overhead door up to an open position but cannot drive the sprocket in a second and opposite rotational direction to push the overhead door down to a closed position.

Preferably, the kit also includes a spring configured to be energized as the overhead door travels a final segment of its path towards the open position, to thereby assist the overhead door as it begins its path toward the closed position.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of an overhead door system and retrofit kit including a center-mounted overhead door opener having a spring-assisted one-way bearing mechanism according to embodiments of the present disclosure.

FIG. 2 is a side view of a spring assisted overhead door system according to embodiments of the present disclosure.

FIG. 3 is a schematic side view of an overhead door opener system in which the overhead door is in a lowered position according to embodiments of the present disclosure.

FIG. 4 shows a one-way bearing according to embodiments of the present disclosure.

FIG. 5 shows the one-way bearing of FIG. 4 when rotated in the second rotational direction B, opposite the first rotational direction A according to embodiments of the present disclosure.

FIG. 6 is a top view of a motor unit according to embodiments of the present disclosure.

FIG. 7 is a view of a motor unit with a drive wheel that is a toothed drive pulley and a toothed belt according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following description recites various aspects and embodiments of the present disclosure. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

A one-way bearing is any device that is capable of transmitting force when rotated in one direction but does not transmit force when rotated in the opposite direction. Many one-way bearings have two pieces that rotate relative to one another when rotated in the direction in which force is not transmitted, and that do not rotate relative to one another when rotated in the opposite direction. Some examples of a one-way bearing are one-way clutch bearings or Sprag style bearings that are constructed from a drawn cup with needle roller clutches and have a small radial section height. They are often called one-way bearings, anti-reverse bearings, and clutch bearings. Preferably, the units are compact, lightweight and operate directly on a shaft; they are also suitable for transmitting high torque.

An overhead door opener having such a mechanism is shown and described in U.S. patent application Ser. No. 16/805,771 filed Feb. 29, 2020, entitled “Mechanism for Opening and Closing an Overhead Door Including One Way Bearing,” published as U.S. Patent Application Publication No. 2021/0270079. Another overhead door assembly using a one-way bearing is shown and described in U.S. patent application Ser. No. 17/360,069 filed Jun. 28, 2021, entitled “Overhead Door Opener System with One Way Bearing.” Use of a spring in connection with an overhead door having a one-way bearing safety mechanism is shown and described in U.S. patent application Ser. No. 17/355,112 filed Jun. 22, 2021, entitled “Spring Assisted Overhead Door.”

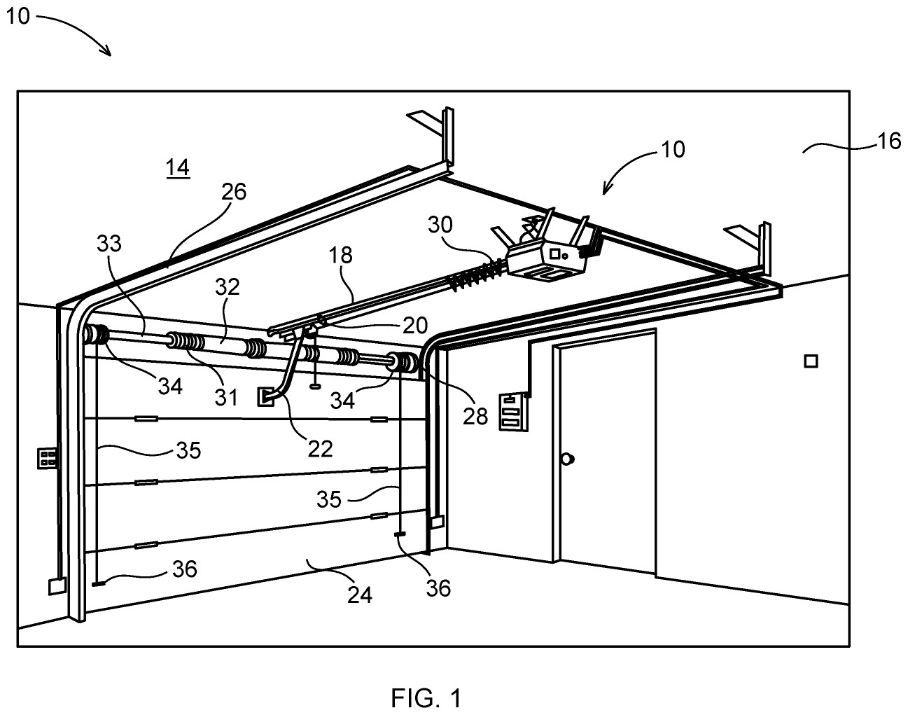

FIG. 1 is an isometric view of an overhead door system 10 and retrofit kit including a center-mounted overhead door opener 12 having a spring-assisted one-way bearing mechanism according to embodiments of the present disclosure. The center-mounted overhead door opener 12 can be used in a garage 14. More specifically, the center-mounted overhead door opener 12 is mounted to a ceiling 16 of the garage 14 and includes a rail 18 extending therefrom with a carriage 20 attached having a connecting member 22 extending to a multiple paneled garage door 24 positioned for movement along a pair of door tracks 26 and 28. The center-mounted overhead door opener 12 has a motor coupled to the door 24 by the carriage 20 and connecting member 22, by which the motor moves the door 24. The carriage 20 can be moved by a chain (See, for example, the opener in U.S. Pat. No. 7,164,246), belt (See, for example, U.S. Pat. No. 4,885,872), screw or worm gear (See, for example, the opener in U.S. Pat. No. 5,588,257) or other transmission components that allow the motor to move the carriage 20 along the rail 18. Reference to this transmission component is made with the term “chain” without loss of generality and a person of ordinary skill in the art will understand that a belt, loop, chain, or other mechanical equivalents can be used.

At one or more of several available positions between the motor and the door 24 is a one-way bearing that allows force to be transmitted in a first rotational direction but does not allow force to be transmitted in a second rotational direction due to free rotation of the one-way bearing. The first direction is upward, meaning the bearing allows the connecting member 22, carriage 20, and rail 18, to exert an upward force on the door 24, but are not capable of exerting a downward force in the second direction which is downward, opposite to the first direction. A spring 30 is positioned on or adjacent to the rail 18 and urges the door 24 forward and downward to initiate travel of the door 24. In some embodiments the spring 30 can be positioned on or near the tracks 26, and 28 and may include a first spring 30 for the track 26 and a second spring 30 for the track 28. In other embodiments the spring 30 can be on the opposite side of the carriage 20 between the structure 46 and the carriage 20 and as such operates in tension and not compression. Otherwise, the operation can be the same as a compression configuration. The spring may be an elastic polymer or any other suitable biasing member.

In the door's upward-most position, the carriage 20 is nearest the opener 12 and the spring 30 is energized between the opener 12 and the carriage 20. The energy in the spring 30 is stored as long as the door 24 is stationary. The motor draws the carriage 20 toward the motor to ensure the door 24 remains in this upmost position despite the spring 30 being biased to urge the door 24 forward.

Upon receiving a command to lower the door 24, the motor rotates in the second direction and allows the spring 30 to move the carriage 20 forward and the door 24 begins to descend. After moving a certain distance along the rail 18, the weight of the door 24 is sufficiently influenced by gravity that the door 24 descends and the one-way bearing 48 does not spin and the door 24 continues moving. This distance is used to determine the length of the spring 30. The spring 30 can be long enough to push the door 24 beyond this distance. At this point the door 24 is held up by force in the one-way bearing in the first direction, which is an upward direction. The motor continues to rotate in the second direction until the door 24 reaches the closed position. The upward direction of the force applied by the motor through the one-way bearing does not pull or push the door 24 downward; rather, it resists gravity acting on the door 24.

In some embodiments the spring 30 can be a helical spring wound around the rail 18. In other embodiments the spring 30 can be adjacent to but not encircling the rail 18. In still other embodiments the spring 30 can be fastened to the carriage 20. In other embodiments the spring 30 is free to slide along the rail 18 between the carriage 20 and the opener 12.

The opener 12 can also include a conventional lift assist 32 that comprises a shaft 33 mounted to in the garage 14 transverse to the movement of the door 24 and having a torsion spring 31 that carries weight of the door 24. The torsion spring 31 is biased to carry the weight of the door 24 to ease the burden on the motor when raising and lowering the door 24. The torsion spring 31 can be wound around the shaft 33 or it can be adjacent to the shaft 33. The lift assist 32 also includes spools 34 at each end of the shaft 33, and cables 35 wound around the spools 34 and connected to the door 24 at an anchor 36. There may be an anchor 36 on each side of the door 24.

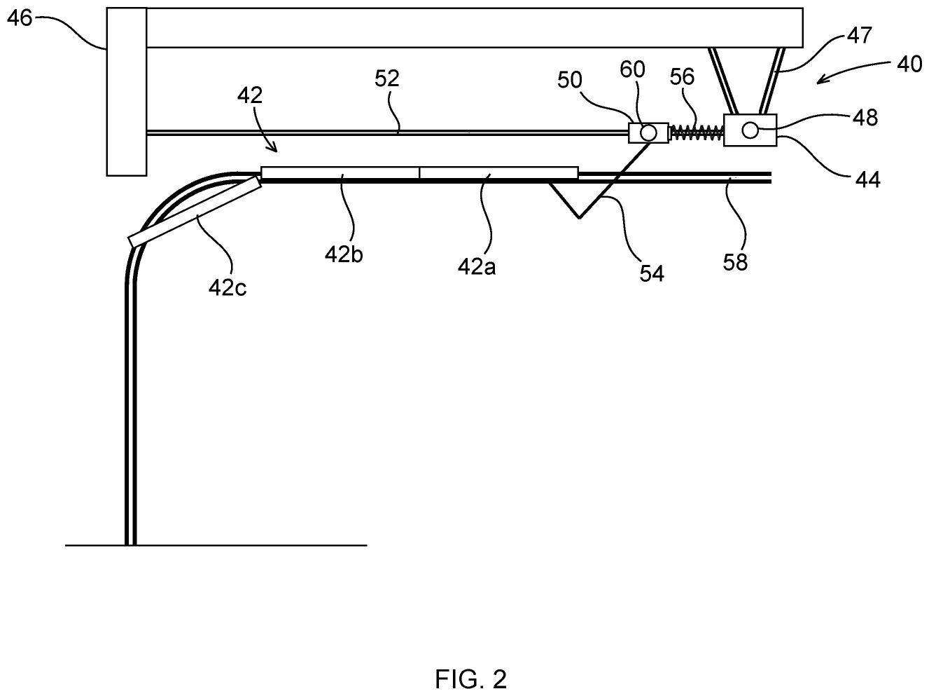

FIG. 2 is a side view of a spring assisted overhead door system 40 according to embodiments of the present disclosure. The system 40 includes an overhead door 42 that includes a series of panels 42a, 42b, and 42c. There may be any number of panels making up the door 42. The system 40 also includes a ceiling-mounted overhead door opener 44 mounted to a structure 46 such as a garage. The opener 44 can be secured to the structure 46 with beams 47. The opener 44 includes a motor unit and a one-way bearing safety mechanism 48 that provides the safety features described herein elsewhere in greater detail. The opener 44 includes a carriage 50 and a rail 52. The opener 44 also includes a connecting member 54 that is rigid and connects to the carriage 50 and to the door 42. The connecting member can be in the form of a J-bracket. The opener 44 moves the carriage 50 along the rail 52 to raise and lower the overhead door 42. The system 40 includes tracks 58 that guide the door 42 as it opens and closes. The door 42 may have rollers (not shown) that facilitate movement of the door 42 along the tracks 58.

The system 40 also includes a spring 56 between the opener 44 and the carriage 50. The spring 56 biases the carriage 50 away from the opener 44 when the door 42 is in a fully open position and the carriage 50 is closest to the opener 44. The one-way bearing 48 provides an elegant solution to safety by rendering the motor unable to exert a downward force on the door; however, that solution presents its own difficulty: the horizontal orientation of the door 42 in the elevated position is not pulled downward by gravity. The spring 56 solves that problem by providing sufficient force to the door 42 to cause the door to reach a point at which gravity does in fact cause the door 42 to descend the tracks 58. Therefore, the size and coefficient of the spring 56 can vary. In some embodiments, parameters of the spring 56, such as length, size, and coefficient are determined by the weight of the door 42, and as a function of how the door 42 moves along the tracks 58. In some embodiments the spring 56 has sufficient strength and biasing force that the lower edge of panel 42c is pushed down two feet from the horizontal resting position. The carriage 50 includes a contact point 60 that rests against the spring 56 and provides support for the forces applied by the spring 56.

The door 42 is shown in a partially descended position with the lowest panel 42c beginning to travel downward along the tracks 58. The spring 56 urges the door 42 along the tracks 58 a sufficient distance that the weight of the door 42 is supported by the opener 44, including the connecting member 54, the carriage 50, and the rail 52.

In another aspect, the overhead door 42 has a release point defined as a point at which the weight of the overhead door 42 has moved sufficiently along the tracks 58 and at least partially downward that there is enough of the weight of the door 42 pulling downward due to gravity that the door 42 will continue downward along the tracks 58 if it were left alone. Accordingly, the opener 44 may be able to exert an upward force on the door, through the one way bearing 48 but cannot exert a downward force. This is in part for safety reasons, but without the ability to exert a downward force, the opener 44 may be unable to initiate downward movement from a purely horizontal position since all the weight is resting on the horizontal portion of the tracks 58. The release point may vary depending on the weight of the overhead door 42, the characteristics of the tracks 58 in terms of friction or other impediments.

The spring 56 may be mounted as shown to be loaded in compression when the overhead door 42 is raised. In other embodiments the spring 56 is mounted to the carriage 50 and abuts the opener 44 when reaching the open position. In still other embodiments the spring 56 is loosely carried by the rail 52 and is free to slide along the rail 52.

In some embodiments the spring 56 can be relatively long and can have a relatively low spring coefficient such that the spring 56 urges the door 42 during approximately half the length of the rail 52, and the force of the spring is relatively low. The spring 56 needs only to have enough strength to move enough of the door 42 along the rail track 58 that gravity takes over. The spring 56 gives a small urging to begin the movement and may not constitute a large force relative to the forces output by the opener, or relative to the weight of the door 42.

The opener 44 has sufficient power to overcome the spring 56 to compress the spring 56 as the door 42 moves toward and into the raised position. There it is held in an energized state between the opener 44 and the carriage 50. Many garage door openers have a release mechanism to allow movement of the door relative to the opener 44 for convenience during a power outage for example.

The one-way bearings 48 and spring 56 (as well as spring 30 shown in FIG. 1) can be installed onto the system 40 as a retrofit kit by uncoupling the rail 52 from the opener 44 or from the structure 46. The springs 56, 30 can loosely encircle the rail 52 such that installation is easy to accomplish.

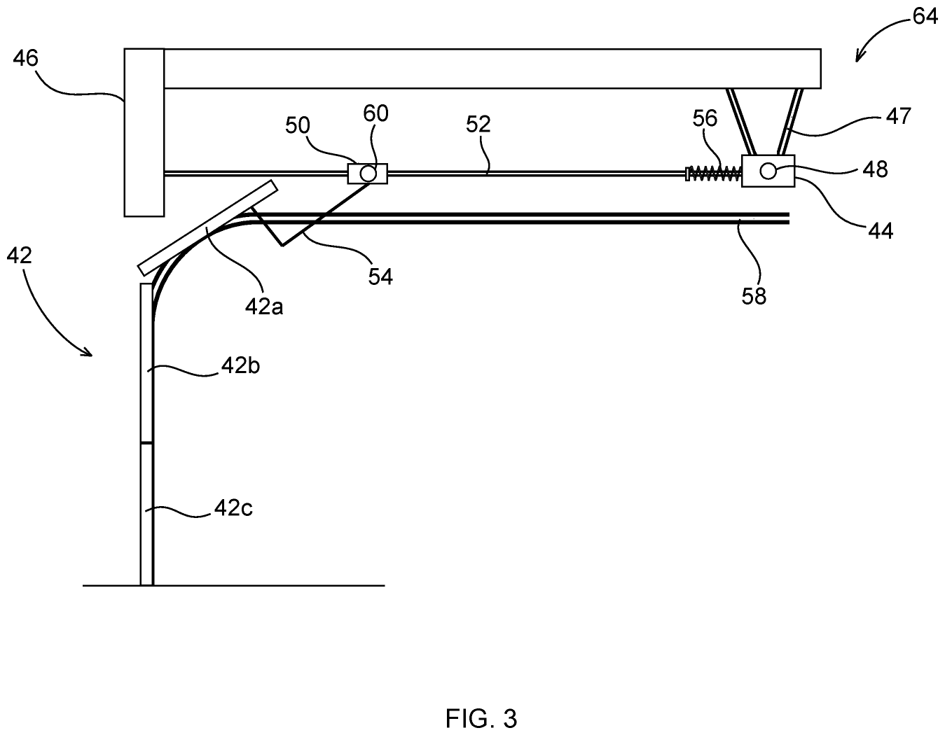

FIG. 3 is a schematic side view of an overhead door opener system 64 in which the overhead door 42 is in a lowered position according to embodiments of the present disclosure. The door 42 is lowered and the carriage 50 is moved forward along the rail 52. The spring 56 is now unenergized, having performed its job of urging the door 42 to a point at which gravity takes over and the one-way bearing(s) do not render the opener 44 unable to move the door 42.

Various embodiments use various types of tension springs. For example, the tension spring may be formed from an elastic material, such as rubber, which is stretched as the door is fully opened. The tension spring may also be an air spring, i.e., formed with a pneumatic cylinder.

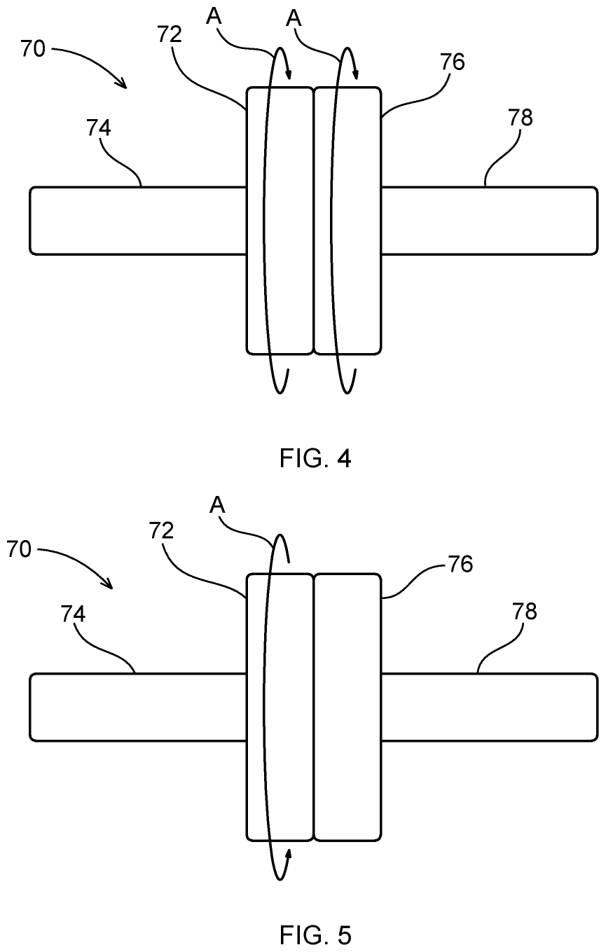

FIG. 4 shows a one-way bearing 70 according to embodiments of the present disclosure. The one-way bearing 70 includes a first component 72 attached to a first shaft 74, and a second component 76 attached to a second shaft 78. The first component 72 and second component 76 contact one another with friction, ratchet teeth, or any other suitable mechanical interface to transfer torque. Rotating the first component 72 in a first rotational direction A causes the second component 76 to also rotate in the first rotational direction A.

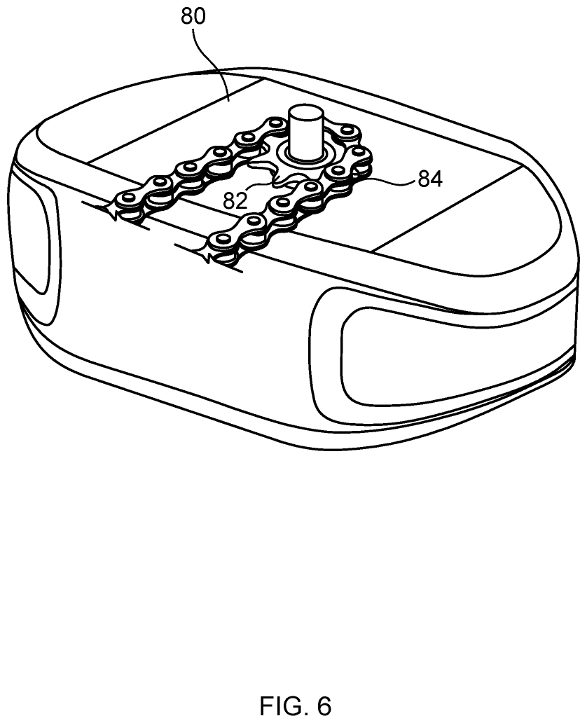

FIG. 5 shows the one-way bearing 70 of FIG. 4 when rotated in the second rotational direction B, opposite the first rotational direction A. In this rotational direction the second component 76 does not rotate with the first component 72, such that the first component 72 can rotate freely and no force is transmitted from the first shaft 74 to the second shaft 78.

The one-way bearings of the present disclosure can take many forms and can be placed in any one or more of several positions. Provided between the motor and a garage door, the operation of the one-way bearing is to transmit force in a first rotational direction, and to rotate freely such that no force can be transmitted in a second rotational direction. Many one-way bearings have such two-piece construction that rotate relative to one another when rotated in the direction in which force is not transmitted, and that do not rotate relative to one another when rotated in the opposite direction. Some examples of a one-way bearing are one-way clutch bearings or Sprag style bearings that are constructed from a drawn cup with needle roller clutches and have a small radial section height. They are often called one-way bearings, anti-reverse bearings, and clutch bearings. The units are compact, lightweight and operate directly on a shaft; they are also suitable for transmitting high torque. Some such bearings are electro-magnetic and can be actuated by the application of electrical power to the bearings.

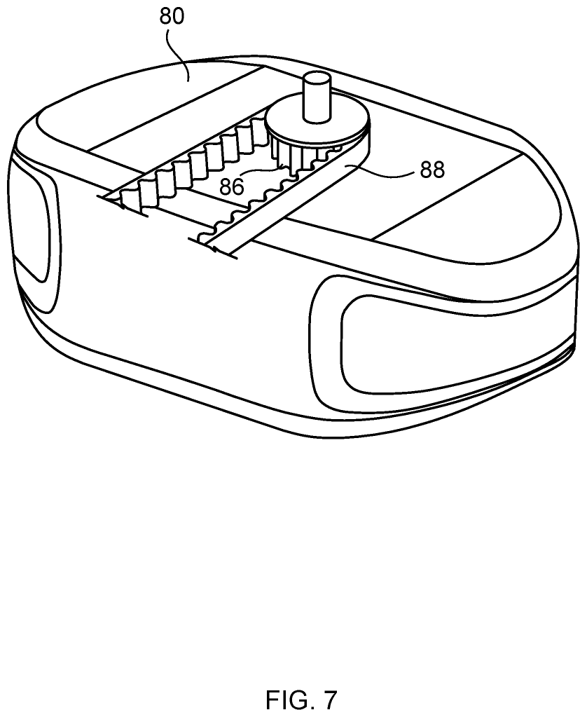

FIG. 6 is a top view of the motor unit 80 shown in FIGS. 1-3. As can be seen, the drive wheel is a sprocket 82, which sits above the housing of the motor unit 80 and which engages a chain 84.

FIG. 7 is a view similar to FIG. 6, except that the drive wheel is a toothed drive pulley 86, which engages a toothed belt 88.

This configuration results in a safer system, namely one that it does not exert a downward force on the door through the drive loop. Rather, the one-way bearing is engaged only to support the weight of the door as the drive loop is moved to lower the door. When the door hits any impediment to downward movement, such as by a child standing under the overhead door, the force against the one-way bearing is released and the door can stop its downward motion, without any downward force applied by the motor.

It is an advantage that this safety feature is mechanical and passive-no electronics are required and as such the safety mechanism provided by the one-way bearing is not subject to a functioning electronics system, a sensor, any logic, or any other input. The response time of the safety feature is instantaneous and is not subject to any network latency or any communication protocol between electronic components.

The one-way bearings shown herein transmit the twisting force, i.e., torque when the motor turns in a first direction that causes the overhead door to raise. The one-way bearing also transmits force in the first direction when the motor is operated in reverse to lower the overhead door. The weight of the door on the bearing creates the force in the first direction as the door is raised and lowered. The first direction is an angular direction when referring to the force applied by rotation of the one-way bearing. Movement in a second direction opposite the first direction, however, causes the one-way bearing to rotate freely. The one-way bearing can be made of two separate parts, one coupled to the output shaft, and one coupled to the sprocket. These parts are not allowed to rotate relative to one another in the first direction but are allowed to rotate relative to one another in the second direction. Accordingly, the motor cannot transmit force in the second direction to the overhead door. The motor can transmit force to the shaft, but the shaft cannot transmit force to the motor 56. Of course, no bearing is completely devoid of force. There may be some resistance and friction, but the overall effect is as close to zero transmitted force as is practically possible. When the overhead door is lowered and contacts an impediment that stops downward movement of the overhead door, it will cause a force to be applied through the door and into the shaft. The one-way bearing will not transmit this force and will also therefore prevent the motor from exerting a downward force on the door. The only downward force then is the weight of the door itself, which can be balanced by a spring. The one-way bearing is therefore a safety mechanism that does not require any power to operate.

When the door is in a fully or mostly retracted position, most of the weight of the door is supported by components such as upper rails above the shaft and therefore the weight is not acting on the shaft. If there is insufficient weight on the shaft to cause the shaft to rotate and lower the door, the motor needs to apply downward force to the shaft. However, the one-way bearing prevents such force in part to prevent downward force from causing an injury. To address this, an electro-mechanical clutch may be coupled to the one-way bearing. The electro-mechanical clutch, when activated, fixes the one-way bearing effectively converting the one-way bearing into a rigid coupling fastened to the shaft that is capable of transmitting force in both directions. When the electro-mechanical clutch is not activated, the one-way bearing operates as a one-way bearing.

In some embodiments the motor can include a lock that can unlock the overhead door in response to a signal. The motor can receive different signals from remote or hard-wired controllers. The signals can cause the motor to raise, lower, or stop the door. Or the signals can actuate lights or sensors or other accessories. In some embodiments the signals cause two or more objects to take action. The signals can be the same signal to open the door, or it can be different from, but tied to the signal to open the door.

The electro-mechanical clutch can be configured to operate for a first distance of travel of the door. For example, the first two feet of movement is in some embodiments sufficient distance for the weight of the door to provide the downward force to close the door. In other embodiments a tension monitor can be used to monitor the tension on the electro-mechanical clutch and, if the tension reaches a certain level, it will release the one-way bearing. The electro-mechanical clutch can be operated with power from a power supply (not shown) to the motor or from the motor or from another outlet in the garage. The electro-mechanical clutch can be configured to fail open, meaning that in the event of power loss the electro-mechanical clutch does not grasp the one-way bearing, permitting the door to be opened manually, and not to exert a downward force onto the door.

As a result, any blockage of the downward movement of the door will cause the one-way bearing to spin. The spools will immediately stop spinning, and even though the motor may continue to rotate, the spools will not continue to rotate and create slack in the cables. Also, the downward force of the door is limited to the weight of the door. In some embodiments, this weight is counterbalanced by a torsion spring on the shaft to further reduce the weight of the door as it moves upward and downward. The torsion spring is connected at one end to the shaft and at the other end to a stationary piece on the structure. The overhead door of the present disclosure is therefore safer and less prone to errors than conventional designs that require sensors and other electronic mechanisms such as force limiters and other similar devices to stop a downward force from causing damage to the source of the perhaps delicate item or person blocking the door. The stoppage of the downward force of the door is not subject to an electronic system working properly. The one-way bearing requires no electronics, no communication, and no software to prevent a dangerous situation from harming someone who finds themselves under the door as it comes down.

Various embodiments use various types of tension springs. For example, the tension spring may be formed from an elastic material, such as rubber, which is stretched as the door is fully opened. The tension spring may also be an air spring, i.e., formed with a pneumatic cylinder.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. An overhead door system, comprising:
a first track and a second track mounted on opposite sides of an opening, each track comprising a vertical portion, a transition portion, and a horizontal portion, the transition portion being between the vertical portion and the horizontal portion;
an overhead door, engaging the first and second tracks on opposite sides of the overhead door and movable along the first and second tracks between a closed, vertical position and a raised, horizontal position; and
a motor unit comprising a motor, the motor unit mounted above the horizontal portions of the first and second tracks;
a rail parallel to and disposed between the horizontal portions of the first and second tracks, the rail carrying a carriage configured to move in a first direction to raise the overhead door and in a second, opposite direction to lower the overhead door;
a connecting member, pivotally attached at one end near a top edge of the overhead door and attached at an opposite end to the carriage; and
a one-way bearing disposed between the motor and the carriage;
whereby the motor, rotating in a first rotational direction, applies force to the carriage to move the carriage in the first direction to raise the overhead door; and
whereby the motor, rotating in a second, opposite rotational direction, does not apply force to the carriage to move the carriage in the second direction to lower the overhead door.

2. The overhead door system of claim 1, further comprising a spring configured to be energized as the overhead door travels a final segment of the horizontal portion of the first and second tracks nearest the motor unit; wherein the spring and gravity provide the force to move the carriage in the second direction to lower the overhead door.

3. The overhead door system of claim 2, wherein the spring is a compression spring held by the rail and wherein the spring is compressed as it is contacted by the connecting member as the overhead door travels the segment of the horizontal portion of the first and second tracks.

4. The overhead door system of claim 3, wherein the spring is a coil spring, with the coils fitted around a portion of the rail.

5. The overhead door system of claim 2, wherein the spring is a compression spring held by the first track and wherein the compression spring is compressed as it is contacted by a portion of the overhead door as the overhead door travels the final segment of the horizontal portion of the first and second tracks.

6. The overhead door system of claim 5, further comprising a second compression spring held by the second track and wherein the second compression spring is compressed as it is contacted by another portion of the overhead door as the overhead door travels the final segment of the horizontal portion of the first and second tracks.

7. The overhead door system of claim 2, wherein the spring is a tension spring that is stretched as the overhead door travels the final segment of the horizontal portion of the first and second tracks.

8. The overhead door system of claim 7, wherein the tension spring is a coil spring.

9. The overhead door system of claim 7, wherein the tension spring comprises an elastic polymer.

10. The overhead door system of claim 7, wherein the tension spring is held by the rail and wherein the spring is stretched as it is contacted by the connecting member as the overhead door travels the final segment of the horizontal portion of the first and second tracks.

11. The overhead door system of claim 1, wherein the carriage is moved by an endless chain driven by a sprocket, which sprocket is in turn driven by the motor.

12. The overhead door system of claim 1, wherein the carriage is moved by an endless belt driven by a pulley, which pulley is in turn driven by the motor.

13. The overhead door system of claim 2, wherein the final segment is between one fourth and three fourths of the horizontal portion of the first and second tracks.

14. The overhead door system of claim 2, wherein the final segment is less than half of the horizontal portion of the first and second tracks.

15. The overhead door system of claim 1, further comprising a latch to uncouple the overhead door from the carriage.

16. The overhead door system of claim 1, further comprising a lift assist, the lift assist comprising:
a shaft mounted above the opening and comprising a first and second spool;
a first cable connected at one end to the overhead door near its bottom on one side and connected at its other end to the first spool;
a second cable connected at one end to the overhead door near its bottom on an opposite side and connected at its other end to the second spool; and
a torsion spring;
wherein, the first and second cables are wound around the first and second spools, respectively, when the overhead door is in its open position, and wherein, as the overhead door is lowered, the first and second cables are unwound from the first and second spools, respectively, and the torsion spring is energized.

17. A kit to retrofit an overhead door opener comprising a motor that drives a sprocket that, in turn, drives an endless chain, the kit comprising:
a one-way bearing configured to be placed between the motor and the sprocket, whereby the motor can drive the sprocket in a first rotational direction to lift an overhead door up to an open position, but cannot drive the sprocket in a second and opposite rotational direction to push the overhead door down to a closed position.

18. The kit of claim 17, further comprising a spring configured to be energized as the overhead door travels a final segment of its path towards the open position, to thereby assist the overhead door as it begins its path toward the closed position

19. The kit of claim 18, wherein the overhead door opener comprises a rail which supports the endless chain, and wherein the spring is a compression coil spring, with coils fitted around a portion of the rail.

20. The kit of claim 18, wherein the spring is a tension spring, which is stretched as the overhead door travels a final segment of its path towards the open position.
